(19) United States
(12) Patent Application Publication
(10) Pub. No.: US 2002/0145591 A1
(43) Pub. Date: Oct. 10, 2002

(54) Lighting unit and lighting apparatus using the same unit

(76) Inventors: Minoru Hato, Osaka (JP); Yoshiharu Abe, Osaka (JP); Shigetaka Douzono, Fukui (JP)

Correspondence Address: RATNERPRESTIA, P O BOX 980, VALLEY FORGE, PA, 19482-0980, US

(21) Appl. No.: 10/091,903

(22) Filed: Mar. 6, 2002

(30) Foreign Application Priority Data
Mar. 21, 2001 (JP) 2001-79928

(51) Int. Cl. G09G 5/00

(52) U.S. Cl. 345/156

(57) ABSTRACT

A lighting unit includes a switch device for performing electrical ON-OFF by depressing a pushbutton, and an EL device having light-emitting sections corresponding to the pushbuttons disposed at least one of above or under the switch device. The EL device includes an optically transparent electrode layer, a light-emitting layer and a backplate layer, where the respective layers are selectively laminated, corresponding to the light-emitting sections, on an insulating base. This structure of the lighting unit realizes visible lighting and allows the lighting unit to be assembled with less components and less steps of mounting components.

### FIELD OF THE INVENTION

The present invention relates to a lighting unit used in an electronic apparatus such as a cellular phone and a personal computer, and a lighting apparatus using the same lighting unit.

### BACKGROUND OF THE INVENTION

Electronic apparatuses, including a cellular phone and a personal computer, have been equipped with various and better functions. Lighting units used in such electronic apparatuses have been, therefore, demanded diversities of lighting and operation.

A conventional lighting unit is described hereinafter with reference to FIG. 7, which shows a sectional view of the conventional lighting unit. In FIG. 7, one of plural pushbuttons 1 made of insulating resin is illustrated. Pushbutton 1 includes light-guiding section 1A semitransparent or colored in milk-white as well as light-proof section 1B covering light-guiding section 1A and colored in dark. On an upper surface of pushbutton 1, display section 1C—a top face of light-guiding section 1A—is disposed showing letters, marks or designs.

Switch device 2 disposed under pushbutton 1 comprises the following elements:

(a) wired board 3 whose both faces are provided with a plurality of wiring patterns (not shown);

(b) flexible insulating film 4;

(c) insulating spacer 5, whose both faces are provided with adhesive, disposed between board 3 and film 4 to bond these two elements each other;

(d) fixed contact 3A formed on an upper face of wired board 3; and

(e) movable contact 4A, formed on a lower face of film 4, facing contact 3A at a given space.

Switch device 2 structured above thus works as a membrane switch.

Light emitting diode (LED) 6 is mounted on board 3 near fixed contact 3A, LED 7 is mounted on board 3 under liquid crystal display device (LCD) 8, and light-diffusion sheet 9 is placed between LED 7 and LCD 8. Pushbutton 1 movable up and down protrudes from an opening punched on a top surface of housing 10, made of insulating resin, covering those elements discussed above. The conventional lighting unit is thus constructed.

When the top surface of pushbutton 1 is pressed, pressing section 1D disposed beneath a bottom surface of pushbutton 1 presses and bows an upper face of insulating film 4. Then movable contact 4A comes in contact with fixed contact 3A, i.e., switch device 2 is thus electrically conducted. Next, when the pressing forth is removed, pushbutton 1 moves upward due to resilient restoring force of film 4, and movable contact 4A separates from fixed contact 3A. Switch device 2 is thus restored to a former status.

When LED 6 emits light, the light travels through light-guiding section 1A and illuminates display section 1C above. This structure allows a user to identify pushbutton 1 by recognizing the letter, mark, or design displayed on display section 1C even in dark environment.

Further, when LED 7 emits light, the light is diffused by light-diffusion sheet 9 and illuminates LCD 8 above, which allows the user to recognize letters or marks displayed on LCD 8 with ease.

However, in this conventional lighting unit, LED 6 and LED 7 illuminate pushbutton 1 and LCD 8 respectively. Therefore, when numbers of pushbuttons 1 are arrayed, the same number of LEDs are required, and when a size of LCD 8 is greater than a certain size, plural LEDs are needed in order to illuminate the screen of LCD 8 uniformly. As a result, a number of components increases, and it takes time to mount the components onto board 3.

### SUMMARY OF THE INVENTION

The present invention aims to provide a lighting unit comprising the following elements:

a plurality of pushbuttons;

a switch device for performing electrical ON-OFF by pressing at least one of the pushbuttons; and

an EL device including light-emitting sections corresponding to pushbuttons disposed at least one of above or under the switch device.

The light-emitting section of the EL device includes at least one of an optically transparent electrode layer and a backplate layer, formed partially on an optically transparent insulating base, and both of the layers and a light-emitting layer, selectively laminated on the optically transparent insulating base.

### BRIEF DESCRIPTION OF THE DRAWINGS

FIG. 1 is a sectional view of a lighting unit in accordance with a first exemplary embodiment of the present invention.

FIG. 2 is a partial sectional view of an EL device in accordance with the first exemplary embodiment of the present invention.

FIG. 3 is an exploded perspective view of the EL device shown in FIG. 2.

FIG. 4 is a partial sectional view of an EL device in accordance with a second exemplary embodiment of the present invention.

FIG. 5 is a block diagram of a lighting apparatus in accordance with a third exemplary embodiment of the present invention.

FIG. 6 shows an outward appearance of a keyboard in accordance with a third exemplary embodiment.

FIG. 7 is a sectional view of a conventional lighting unit.

### DESCRIPTION OF PREFERRED EMBODIMENTS

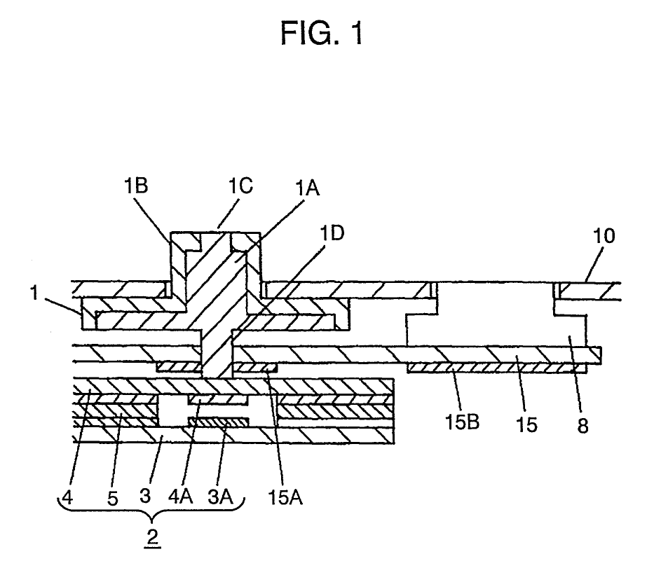

Exemplary embodiments of the present invention are demonstrated with reference to FIG. 1 through FIG. 6

First Exemplary Embodiment

FIG. 1 is a sectional view of a lighting unit in accordance with the first exemplary embodiment of the present invention. In FIG. 1, a plurality of pushbuttons 1 are made of insulating resin such as ABS resin, polycarbonate, or acrylic resin. Each one of pushbuttons 1 includes light-guiding section 1A semitransparent or colored in milk-white as well as light-proof section 1B covering light-guiding section 1A and colored in dark. On an upper surface of pushbutton 1, display section 1C which is a top face of light-guiding section 1A is disposed showing letters, marks or designs.

Switch device 2 disposed under pushbutton 1 comprises the following elements:

(a) wired board 3—made of paper phenol or glass epoxy—whose both faces are provided with a plurality of wiring patterns (not shown);

(b) flexible insulating film 4 made of polyethylene terephthalate or polyimide;

(c) insulating spacer 5, whose both faces are provided with adhesive, disposed between board 3 and film 4 to bond these two elements each other;

(d) fixed contact 3A formed on an upper face of wired board 3; and

(e) movable contact 4A, formed on a lower face of film 4 and facing contact 3A at a given space.

Switch device 2 structured above thus works as a membrane switch.

EL device 15 is disposed above switch device 2, and a plurality of light-emitting sections 15A and 15B are disposed beneath EL device 15 under pushbutton 1 and display devices, such as LCD 8, disposed beside pushbutton 1. A through-hole is provided to light-emitting section 15A for pressing section 1D—protruding from a lower face of pushbutton 1—to extend through the hole.

Pushbutton 1 movable up and down protrudes from an opening punched on a top surface of housing 10 made of insulating resin and covering those elements discussed above. The lighting unit is thus constructed.

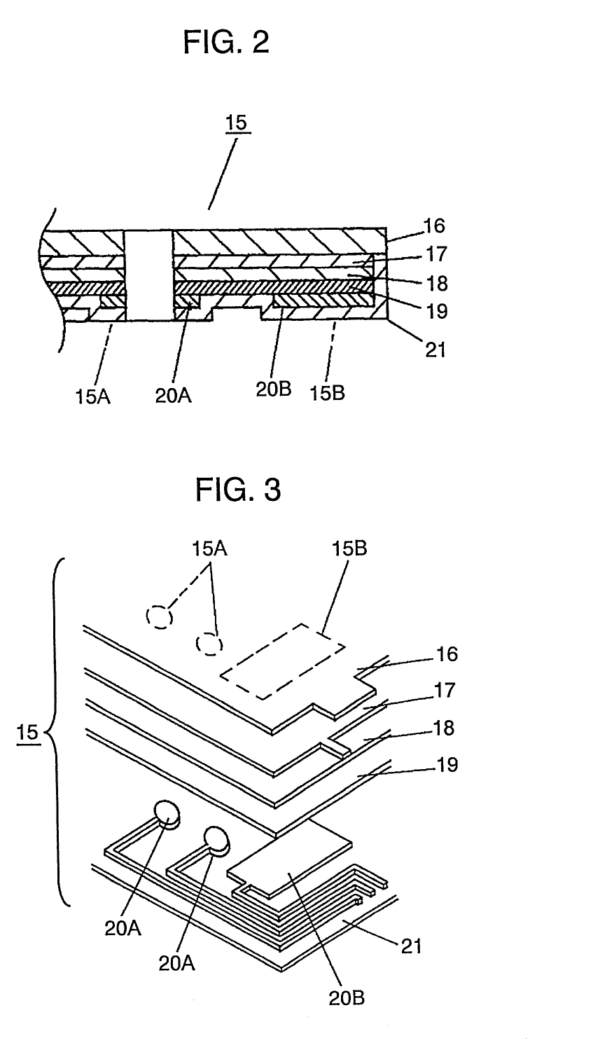

FIG. 2 is a partial sectional view of an EL device in accordance with the first exemplary embodiment of the present invention. FIG. 3 is an exploded perspective view of the EL device shown in FIG. 2. In FIGS. 2 and 3, optically transparent electrode layer 17 is formed on the entire lower surface of film-like insulating base 16, which is made of polyethylene terephtharate or polyimide. On layer 17, light-transmissible synthetic resin is printed, in which indium tin oxide is dispersed by a spattering method or an electron beam method.

Further on layer 17, light-emitting layer 18 is printed, in which base material for light emitting such as zinc sulfide is dispersed into fluororubber or cyano-system resin. Still further on layer 18, dielectric layer 19 is printed, in which barium titante or the like is dispersed into high-dielectric resin.

Further on layer 19, a plurality of backplate layers 20A made of silver or carbon resin system and corresponding to respective pushbuttons 1 as well as a plurality of backplate layers 20B corresponding to respective LCDs 8 are selectively printed. A plurality of light-emitting sections 15A and 15B are thus formed, and insulating layer 21 made of epoxy resin or polyester resin covers those light-emitting sections, thereby forming EL device 15.

In the structure discussed above, when the top surface of pushbutton 1 is pressed, pressing section 1D disposed beneath a bottom surface of pushbutton 1 presses and bows an upper face of insulating film 4. Then movable contact 4A comes in contact with fixed contact 3A, i.e., switch device 2 is electrically conducted. Next, when the pressing force is removed, pushbutton 1 moves upward due to resilient restoring force of film 4, and movable contact 4A separates from fixed contact 3A. Switch device 2 is thus restored to a former status.

When a voltage is applied to between optically transparent electrode layer 17 and a plurality of backplate layers 20A or 20B, light-emitting sections 15A and 15B, both sections being sandwiched by these layers, emit light and illuminate pushbutton 1 and LCD 8 disposed above.

In FIG. 3, when a voltage is applied, for instance, to between layer 17 and backplate layers 20A, light-emitting section 15A emits light, and this light travels through light-guiding section 1A to illuminate display section 1C of pushbutton 1 shown in FIG. 1. The letters, marks or designs shown on display section 1C thus can be recognized by a user to identify pushbutton 1 even in dark environment.

When a voltage is applied to between layer 17 and backplate layers 20B, light-emitting section 15B emits light, and this light illuminates LCD 8 shown in FIG. 1 and disposed above section 15B, so that letters displayed on LCD 8 can be easily recognized.

In the lighting unit, numbers of pushbuttons 1 are arrayed, and a plurality of backplate layers 20A are disposed corresponding to these pushbuttons. They are not illustrated in FIG. 1.

Respective pushbuttons 1 are illuminated by numbers of light-emitting sections 15A, so that each one of pushbuttons 1 can be individually illuminated, or a plurality of pushbuttons can be simultaneously illuminated.

According to the first embodiment, the lighting unit includes EL device 15 above switch device 2, and EL device 15 has light-emitting sections 15A corresponding to each one of pushbuttons. On the lower face of EL device 15, optically transparent electrode layer 17, light-emitting layer 18 and backplate layer 20 are selectively laminated corresponding to the light-emitting sections. In this lighting unit, the plurality of light-emitting sections 15A illuminate respective pushbuttons 1. This structure allows a single EL device to illuminate plural pushbuttons, so that the lighting makes letters, marks and designs visible enough to a user, and a lighting unit having less components and requiring less mounting steps is obtainable.

In the lighting unit, display devices such as LCD 8 are disposed beside pushbutton 1, and EL device 15 including light-emitting sections 15B—corresponding to each one of display devices-is disposed above switch device 2. In addition to illuminating pushbutton 1, single EL device 15 illuminates the display devices including LCD 8.

In the above descriptions, EL device 15 is disposed above switch device 2. However, EL device can be placed under switch device 2 provided moving contact 4A on insulating film 4 and fixed contact 3A on wired board 3 are made of optically transparent material as same as optically transparent electrode layer 17. In this case, the through-hole, through which pressing-section 1D of lower surface of pushbutton 1 extends, is not needed. Therefore, a plurality of light-emitting sections 15A as a whole can illuminate the entire lower face of respective pushbuttons 1, so that the pushbuttons can be illuminated more visibly.

Regarding a structure of EL device 15, optically transparent electrode layer 17 and light-emitting layer 18 are formed on an overall surface of EL device 15, then plural backplate layers 20A and 20B are selectively provided to form plural light-emitting sections 15A and 15B. However, EL device 15 can be constructed the other way around, i.e., plural optically transparent electrode layers 17 are selectively disposed, and backplate layers 20 are formed on the overall surface of EL device 15 to dispose plural light-emitting sections.

Further, both of layers 17 and layers 20 are selectively provided, and ones of these two kinds of layers are connected with conductive patterns, and light-emitting layer 18 and dielectric layer 19 are selectively formed in plural. This structure reduces a volume of the layers in EL device 15.

The present invention is applicable not only to a membrane switch as discussed above but also to other types of switch devices. For instance, a switch device, in which a domed movable contact made of resilient metal foil is placed above a fixed contact on a wired board, allows a pushbutton to press the movable contact to bow downward, so that the movable contact and the fixed contact are conducted each other. Another instance is, a domed movable contact made of rubber or elastomer is brought into contact with a fixed contact. Still another instance is a switch device employing a single push-switch.

### Second Exemplary Embodiment

The second embodiment is demonstrated hereinafter with reference to the accompanying drawings. Elements similar to those in the first embodiment have the same reference marks, and the descriptions thereof are omitted here.

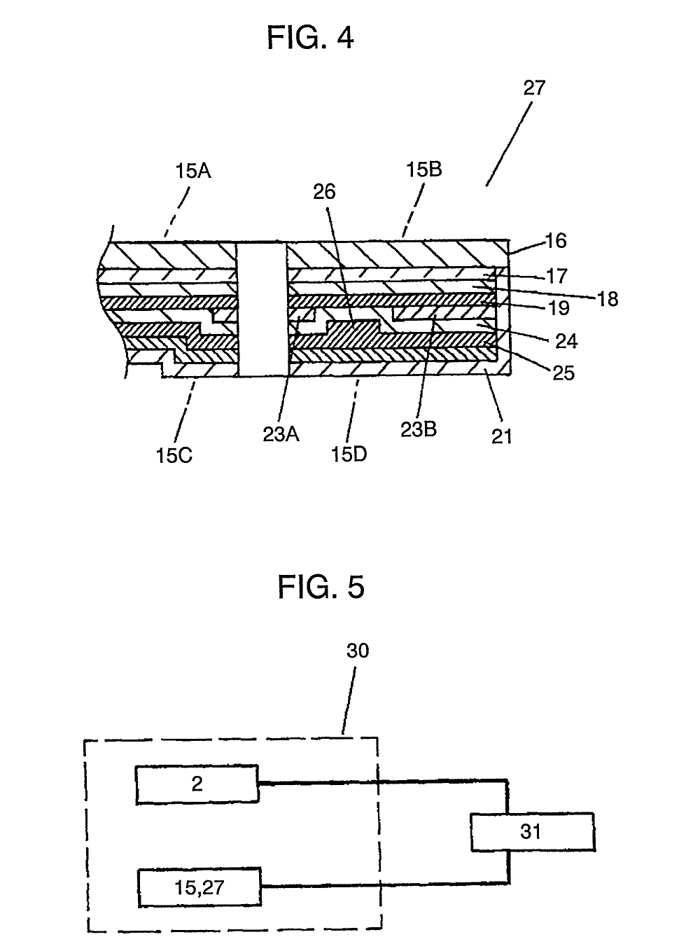

FIG. 4 shows a partial sectional view of an EL device in accordance with the second embodiment. In FIG. 4, optically transparent electrode layer 17 is formed on the entire lower surface of optically transparent insulating base 16. Light-emitting layer 18 and dielectric layer 19 are printed thereon. This structure is the same one as the first embodiment.

Plural intermediate electrode layers 23A and 23B are printed selectively on dielectric layer 19 disposed above light-emitting sections 15A and 15B which correspond to each one of the pushbuttons and each one of the display devices respectively. Intermediate electrode layers 23A and 23B are optically transparent and made of optically transparent synthetic resin in which indium tin oxide or the like is dispersed. On layers 23A and 23B, light-emitting layer 24, which emits light having different color from that of light-emitting layer 18, is printed. Further on light-emitting layer 24, dielectric layer 25 is printed.

Backplate layer 26 is printed on entire lower face of layer 25, so that light-emitting sections 15C and 15D—emitting light in colors different from those of sections 15A and 15B—are formed. Insulating layer 21 made of epoxy resin, polyester resin or the like covers those layers discussed above, thereby forming EL device 27.

In other words, a plurality of intermediate electrode layers 23A, 23B are additionally prepared comparing with the first embodiment, so that light-emitting sections 15C, 15D are formed between optically transparent electrode layer 17 and backplate layer 26. Light-emitting sections 15C, 15D emit light in colors different from those of sections 15A, 15B.

EL device 27 is disposed at least one of above or under switch device 2 which performs electrical ON-OFF by pressing pushbutton 1, so that lighting unit (not shown) is constructed. This is the same as the first embodiment.

In the structure discussed above, when a voltage is applied to between layer 17 and layer 23A or 23B, light-emitting sections 15A and 15B disposed in light-emitting layer 18 between those layers emit light and illuminate pushbutton 1 placed above light-emitting sections 15A and 15B. When a voltage is applied to between backplate layer 26 and layer 23A or 23B, light-emitting sections 15C and 15D emit light and illuminate LCD 8 placed above sections 15C and 15D.

For instance, when a voltage is applied to between layer 17 and layer 23 B, light-emitting section 15A emits light, and this light travels through light-guiding section 1A to illuminate display section 1C of pushbutton 1 shown in FIG. 1. The letters, marks or designs shown on display section 1C thus can be recognized by a user to identify pushbutton 1 even in dark environment.

Further, when a voltage is applied to layer 17 and layer 23B, light-emitting section 15B emits light and illuminates LCD 8 placed above, so that characters displayed on LCD 8 can be easily recognized. This is the same as the first embodiment.

When a voltage is applied to between backplate layer 26 and intermediate electrode layers 23A or 23B, light-emitting sections 15C and 15D emit light and illuminate respectively pushbutton 1 and LCD 8 placed above the light-emitting sections. Since sections 15C and 15D emit light in color different from sections 15A and 15B, pushbutton 1 and LCD 8 are illuminated differently from when sections 15A and 15B illuminate them.

If light-emitting layer 18 is prepared to emit light in blue-green, and layer 24 is to emit light in red, pushbutton 1 and LCD 8 are illuminated in blue-green when light-emitting sections 15A and 15B emit light. When light-emitting sections 15C and 15D emit light, pushbutton 1 and LCD 8 are illuminated in red.

If a voltage is applied to all of optically transparent electrode layer 17, intermediate electrode layers 23A, 23B and backplate layer 26, every light-emitting section 15A, 15B, 15C and 15D emits light. Therefore, pushbutton 1 is illuminated in white (color mixed with blue-green from section 15A and red from section 15C), and LCD 8 is illuminated also in white (color mixed with light from section 15B and that from section 15D).

According to the second embodiment discussed above, a plurality of intermediate electrode layers 23A, 23B of optically transparent are provided selectively between optically transparent electrode layer 17 and backplate layer 26, so that a plurality of light-emitting layers 18 and 24 are formed between respective layers. These light-emitting layers emit light in different colors respectively. This structure allows a plurality of light-emitting sections 15A, 15B, 15C and 15D of EL device 27 to emit light in different colors respectively.

A plurality of the intermediate electrode layers are prepared, so that three light-emitting layers, which emit light in red, blue and green respectively, are formed. The three colors are mixed into white, which allows to emit every color. As a result, pushbutton 1 and LCD 8 can be illuminated in various colors, and variety of illuminations can be thus expected.

### Third Exemplary Embodiment

The third embodiment is demonstrated hereinafter with reference to the accompanying drawings. Elements similar to those in the first and the second embodiments have the same reference marks, and the descriptions thereof are omitted here.

FIG. 5 is a block diagram of a lighting apparatus in accordance with the third embodiment of the present invention. In FIG. 5, lighting unit 30 described in the first and the second embodiments comprises a plurality of switch devices 2 and a plurality of EL devices 15, 27. Lighting unit 30 is connected to control circuit 31 formed of a microprocessor, a switch device, and an inverter.

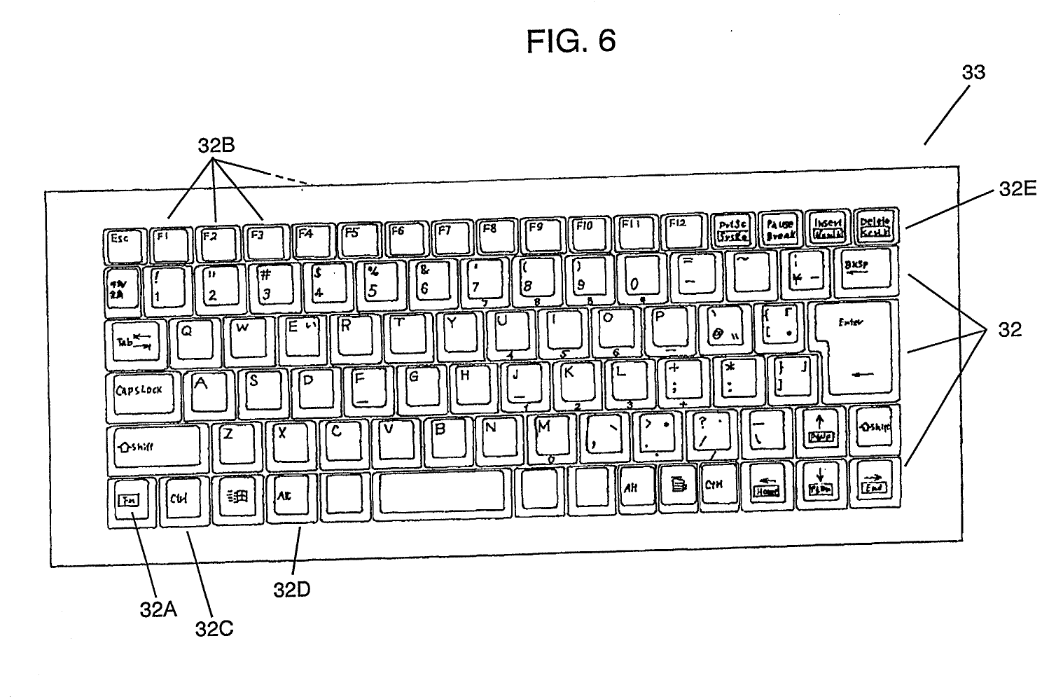

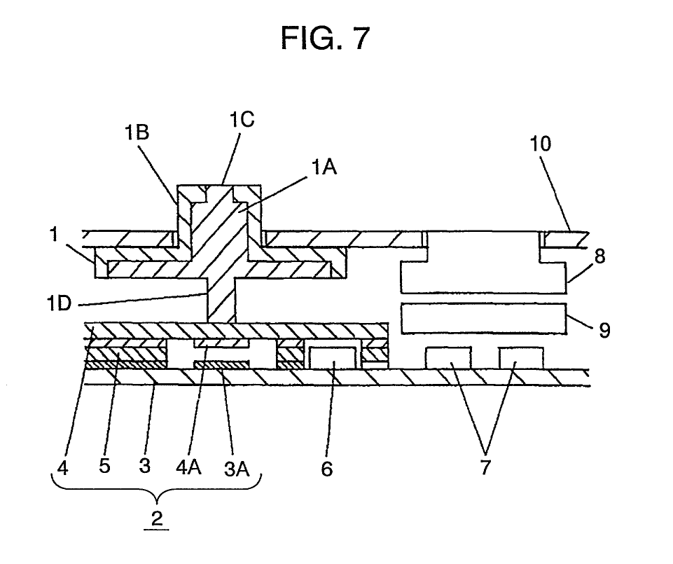

The lighting apparatus, comprising control circuit 31 and lighting unit 30, is used in, e.g., keyboard 33 of a microcomputer system. An outer appearance of keyboard 33 is illustrated in FIG. 6, and a plurality of pushbuttons 32 are arrayed as FIG. 6 shows.

In the structure discussed above, when keyboard 33 is powered, control circuit 31 controls EL devices 15, 27 to emit light, so that each individual pushbutton 32 is illuminated or a plurality of pushbuttons are simultaneously illuminated.

For instance, control circuit 31 applies a voltage to EL devices 15, 27, so that a plurality of light-emitting sections are illuminated simultaneously. Then all pushbuttons 32 arrayed on keyboard 33 are illuminated from their bottoms, and letters, marks and designs put on pushbuttons 32 can be identified by a user even in dark environment.

When the keyboard is powered or if a battery needs power, control circuit 31 controls the EL device such that the EL device blinks for a given time, so that pushbutton 32 can tell a user with blinks that the keyboard is powered or the battery needs power.

As shown in FIG. 5, control circuit 31 is connected to a plurality of switch devices 2 of lighting unit 30, and controls the light emission of the EL device responsive to operation of pushbuttons 32. This control allows a pushbutton to be illuminated responsive to a given instruction of the pushbutton.

For instance, when button “Fn” 32A is depressed, control circuit 31 detects ON-OFF of switch device 2 and controls the EL device to illuminate only buttons 32B including “F1”, “F2”, . . . . Then a user can notice which buttons should be pressed after the user pressed button “Fn” 32A.

If EL device 27 demonstrated in the second embodiment is used, more variety of illuminations can be expected because EL device 27 emits light in plural colors.

For instance, if the microcomputer system encounters some trouble with every pushbutton 32 illuminated in blue-green, control circuit 31 controls the EL device to illuminate button “Ctrl” 32C, button “Alt” 32D and button “Del” 32E in red, so that measures against the trouble can be taken with ease.

According to the third embodiment discussed above, lighting unit 30 is connected to control circuit 31, which controls EL device 15, 27 to illuminate pushbuttons 32. This structure of the lighting apparatus realizes visible and variety of illuminations, and allows the lighting apparatus to be assembled with less components as well as less steps of mounting components.

Control circuit 31 is connected to a plurality of switch devices 2 of lighting unit 30, and controls the EL device to emit light by depressing a predetermined pushbutton, so that variety of illuminations as follows are achievable: When a pushbutton having a specific function is depressed, the buttons related only to this specific function are illuminated, or a plurality of pushbuttons are sequentially illuminated following the operation procedure.

The present invention thus provides visible lighting, a lighting unit assembled with less components as well as less steps of mounting components, and a lighting apparatus using the same lighting unit.

What is claimed is:

1. A lighting unit comprising:
a pushbutton;
a switch device for performing electrical ON-OFF by depressing said pushbutton;
an EL device including a light-emitting section corresponding to said pushbuttons provided to at least one of above and under said switch device,
wherein the light-emitting section of said EL device includes at least one of an optically transparent electrode layer and a backplate layer, formed partially on an optically transparent insulating base, and both of the layers and a light-emitting layer, selectively laminated on the optically transparent insulating base.

2. The lighting unit of claim 1, wherein said EL device includes another light-emitting section corresponding to a display device placed beside said pushbutton.

3. The lighting unit of claim 1, further comprising:
an optically transparent intermediate electrode layer selectively laminated between the optically transparent electrode layer and the backplate layer; and
a first light-emitting layer provided between the optically transparent electrode layer and the intermediate electrode layer, and a second light-emitting layer provided between the intermediate electrode layer and the backplate layer, wherein the first layer emits light in different color from the second layer.

4. A lighting apparatus comprising:
said lighting unit, as defined in claim 1 or claim 3, for illuminating said pushbuttons; and
a control circuit, coupled to said lighting unit, for controlling light emission from said EL device.

5. The lighting apparatus of claim 4, wherein said control circuit controls said EL device by depressing a predetermined pushbutton.

6. A lighting apparatus comprising:
said lighting unit, as defined in claim 2, for illuminating said display device; and
a control circuit, coupled to said lighting unit, for controlling light emission from said EL device.

7. The lighting apparatus of claim 6, wherein said control circuit controls said EL device by depressing a predetermined pushbutton.
